(19) United States
(12) Patent Application Publication
(10) Pub. No.: US 2014/0048006 A1
(43) Pub. Date: Feb. 20, 2014

(54) Side force enhancer for planing objects

(71) Applicant: Willi H. Ellermeier, St. Helena, CA (US)

(72) Inventor: Willi H. Ellermeier, St. Helena, CA (US)

(21) Appl. No.: 13/573,069

(22) Filed: Aug. 17, 2012

(51) Int. Cl. B64C 25/54; B63B 35/73

(52) U.S. Cl. CPC B64C 25/54; B63B 35/73
USPC 114/292; 441/65

(57) ABSTRACT

Applicant's Side Force Enhancer for use with a slender planar object which hydrodynamically planes proximate to the interface of a liquid and gas environment. The side force enhancement device comprises a plate having an inner surface and outer surface terminating at an upstream leading edge and downstream trailing edge, said plate mounted to the upper surface of said planar object at a predetermined location along the length of said planar object's side edge. The side force enhancing plate's upper most surface is positioned a predetermined distance below the upper surface of said planar object, said plate's lower most surface positioned a predetermined distance below said planar object's lower surface. The inner surface of said plate is proximate to said planar object's side edge, defining an angular relationship therewith. Said plate has a preferred length to height ratio and said angular relationship defines a preferred range of angle. The gap between the plate and said planar object, its angle with said planar object's side edge and yaw axis influences the maneuverability of said planar object at the liquid gas interface as a function of speed and pitch.

### FIELD OF THE INVENTION

The invention pertains to the field of planing objects (“PO's”) moving along a liquid-gas interface such as a water ski, wakeboard, surfboard, seaplane float or like planar objects.

### REFERENCE TO RELATED APPLICATIONS

This application is an original first filing; no provisional, continuation or other document, has been filed with the United States Patent & Trademark Office by Applicant pertaining to this subject matter.

### ACKNOWLEDGMENT OF GOVERNMENT SUPPORT

This invention was not developed with any type of government support. The government has no rights in applicant's invention.

### BACKGROUND OF THE INVENTION

Planing objects (“PO's”) may be defined as an object having the attribute of “slenderness” according to a hierarchy of scaled lengths. The width and thickness of a ski, for example, are substantially less than its overall length. In the instance of a slalom ski, a typical ratio of the width to the length between 0.1:1 and 0.2:1. The thickness of the ski at each side thereof along the length and defining the width of the ski may be properly referred to as the side edges.

The distinguishing feature of hydrodynamic planing as addressed herein is the limitation of substantial contact of the PO with the liquid. In other words, the PO is not truly immersed in the liquid, but acts substantially at the interface of liquid and gas; in this case substantially on the surface of the water or liquid. The path of the PO varies from substantially straight to curved at said interface. Such paths are resultant from speed and attitude of parameters such as yaw, pitch and roll angles of the object. Of the four factors previously described, variations in terms of water skis, wakeboards and surfboards are generally controlled by the force and position of a human engaged in using said ski or board, whether intended or not. Certainly, it is the intent of the user to assert position and control in an effort to control the ski or board with specific results in mind. That is not to say, however, that certain positions or forces exerted by such a user are at times, involuntary, but generally with the same result—action of the ski or board directly attributable to the four identified factors.

The characteristic of the PO in reacting to these factors of speed, yaw, pitch and roll, may be referred to as its “maneuverability.” The maneuverability of the PO constitutes the desirability of the PO for differing ski styles and functions.

In the prior art, most attention has been directed to stability in the water. Take for example, pontoons on each side of a sea plane, or the outrigger on a pacific island canoe. These additions to the basic vessel (in the case of the canoe) or hull shaped bottom fuselage (in the case of the sea plane) are provided to provide anti-roll characteristics to that particular boat or airplane.

For example, U.S. Pat. No. 6,089,935 issued Jul. 18, 2000 to Fleming, Ill for a Water Ski Attachment. The Fleming reference is indicative of a water ski having an arched fin extending from both sides of the ski and forming a continuous channel for water. This configuration teaches increased stability over the standard fin arrangement used on water skis. The attention in this instance is on stability and to a lesser degree maneuverability.

Just as in the case of a professional race car drivers, professional golfers and other sportsmen and sportswomen, the responsiveness of the race car to the driver or the golf club to the golfer are key to providing higher performance. While the average golfer or driver may not be able to fully take advantage of such responsiveness or maneuverability, the more accomplished athlete typically has advanced reaction time, coordination and is able to capitalize on the responsiveness and maneuverability of a high performance tool, be it a race car, golf club, tennis racket, stunt airplane and so on. So it is also with respect to the water skier. The more maneuverable or responsive the ski, the more the accomplished skier, with superior skill, training, reaction time and awareness, may take advantage of this heightened responsiveness to push the performance envelope, changing the path of the ski at will according to his or her manipulation of the ski.

What is needed then, is a modification to the typical planing object, such as a ski, surfboard or other like object, allowing more than simply stability, but additional maneuverability.

The Fleming attachment, extending for a significant portion of the length of the water ski does appear to provide added stability. However, the length of the attachment as configured does not allow for the rapid maneuverability which would be provided by an attachment providing great side force enhancement, but at a discrete point along the length of the ski allowing the effect of pivotability which amplifies the maneuverability. Rapid path change of the PO is limited by the side forces required to move the rearmost portion of the Fleming attachment which, unfortunately, reduces the maneuverability desired by persons such as competitive water skiers.

What is needed is a method, device or attachment which offers maximum maneuverability to a planar object to allow rapid path adjustments with minimized lag time and near instant results.

Just prior to the issuance of the Fleming reference, U.S. Pat. No. 5,957,742 issued Sep. 28, 1999 to Brennan et al., for a Surfboard Side Fin. The Brennan et al. reference teaches a selectively submergible fin doubling as a deck mounted foot rest. the object is for the surfer to submerge the fin by applying downward force to the fin via the foot, thereby increasing maneuverability from that point forward. Lacking in Brennan et al., and the prior art is the creation of continual side force enhancement by virtue of not a selectively submerged fin, but a continually submerged plate or foil, which creates a continual enhancement of the side force on the edge of the planing object, allowing “instant” maneuverability without having to step on the side of the object or otherwise in order to selectively engage additional control.

More particularly, in the case of the water skier, if the side forces acting upon the ski may be continually enhanced, amplifying forces transverse to the PO's path and the immediacy of response thereto, the ski or PO may be more rapidly maneuverable by the skier resulting in more acute control and more immediate responsiveness, thereby effecting far more immediate changes to its geometric path. In the instance of slalom skiing as well as jump skiing, such improved controllability enables a skier to achieve more control around course buoys and a larger cut angle with which to execute a jump.

What is needed then is an adaptation to planing objects providing continual enhanced side forces for constant additional maneuverability.

With respect to water skis, in the prior art, the objective of maneuverability enhancement is typically focused on the reduction of total mass simultaneous with increasing the structural stiffness of the ski, or PO. Less common is any attention paid to altering or manipulating the hydrodynamic interaction of the PO's geometric shape at the interface of the media upon which it rides. This interaction is largely dependent upon the geometry of the wetted contact surface between the PO and the water surface with minor contribution from the portion of the PO in direct contact with, in this case, the air whose primary influence is produced by the ski's tip geometry.

Applicant suggests that emphasis on and understanding of hydrodynamic interaction is overshadowed by current measures applied in the art which concentrate on the reduction of mass and increase in structural stiffness utilizing light-weight materials and associated technology.

Scientific analysis of hydrodynamic interaction of variation of the geometry of PO's with the media upon which the PO rides in concert with testing of appropriate shapes near the side edge of PO's demonstrates that responsiveness and maneuverability of the PO may be employed to achieve superior performance which then may be exploited by water skiers in general, and even more dramatically by those with advanced skills and reaction abilities.

### SUMMARY OF THE INVENTION

In order to provide a constant enhanced maneuverability to planing objects such as a water ski, surfboard, wakeboard, seaplane float, etc., Applicant's invention provides at least one plate positioned near the side edge of the PO. Where two such plates are employed, they are positioned relative to the centerline of the PO either symmetrically or asymmetrically. In the case of water skiers, an assymmetric placement of the side plate may be preferred depending on whether the skier favors placement of one foot in front of the other, or the opposite. A jump skier may prefer a single side plate whereas two plates may be preferable for a slalom skier. These plates may be said to enhance the side forces applied at the edge of the PO and termed side force enhancers or “SFE's.”

Each plate or SFE has a leading edge (“LE”) and a trailing edge (“TE”), said LE being positioned upstream relative to said TE. The LE and TE of the plate define a reference plane. The SFE's thickness may vary along the reference plane. Whereas the LE may be sharp or rounded, in the preferred embodiment, the TE is typically sharp, reminiscent of a subsonic aircraft airfoil. Each SFE comprises a contour, the outer surface thereof being that surface farthest from the PO's centerline, and the inner surface thereof being that surface more proximate to said PO's side edge. Said outer and inner surfaces may be symmetric or asymmetric to said reference plane. A preferred embodiment of Applicant's invention comprises an SFE whose inner surface coincides with the reference plane of said SFE at predetermined angle.

The positioning of the SFE plate or plates is typically defined by two factors; the predetermined angle of the reference plane of said SFE and the minimum distance between the inner surface of said SFE from either side edge of the PO. In the preferred embodiment of Applicant's invention, said predetermined angle may range from +/−10° where said angle equals 0°, said angle representing a reference plane of the SFE parallel to the side edge of the PO. Angles outside the above-mentioned range are not preferred as the resulting parasitic drag of the PO adversely affects the advantages of increased side force enhancement as contemplated by Applicant.

The distance between the closest point of the SFE's inner surface to the corresponding PO side edge ranges between 0 and 30 millimeters.

The preferred ratio length “l” to height “h”, or “l/h”, of the SFE is in the range up to 10. In a preferred embodiment, the length, “l”, of the SFE is 40 millimeters, and the corresponding height, “h” is 15 millimeters, yielding a ratio of 40/15 or approximately 2.67.

This sizing of the SFE has been found to provide the enhanced side force desired, and also an advantage of “pivotability” in comparison with other longer fins found in the prior art.

The SFE and PO are connected rigidly by way of a suspending rod or in another embodiment, the SFE is integral to the construction of the PO. Said construction can also provide for the support and SFE being molded as an integral part of the PO itself.

In the preferred embodiment, the position of the SFE's TE is located near the rear end of the front binding or boot, or downstream from said position for a slalom ski.

In Applicant's invention, three dimensions are utilized to determine the position of the SFE vertically and transverse to the PO and its vertical or yaw axis and relative to the liquid/gas interface or boundary. These dimensions include: first, the distance below the upper surface of the PO in communication with the gas of the substantially uppermost edge of the SFE (distance “a”); second, the distance below the lower surface of the PO in communication with the liquid to the substantially lowermost portion of the SFE (distance “b”); thirdly, the distance between the side edge of the PO and substantially the inner surface of the SFE (distance “c”); and fourthly, the aforementioned height, “h” of the SFE. The distance between the inner surface of the SFE and its outer surface is the effective thickness, “t” of the SFE.

The distance between the side edge of the PO and the SFE's trailing edge may extend up to approximately 200 percent of the distance between leading and trailing edges of the SFE.

Applicant's experience in testing the SFE shows that the shape of the outer surface of the SFE performs better if cambered rather than planar. In embodiments of the invention, more circular arcuate outer surfaces with radii of curvature in the range of between one and fifteen times the SFE's leading to trailing edge distance where tested produced a preference toward larger radii of curvature.

In another embodiment of Applicant's invention, a mounting angle may define a position of substantially the inner surface of the SFE relative to the side edge of the PO.

While this aforesaid angle is typically 0°, some small degree change outwardly from vertical has been found to adapt to individual performance levels and preferences of some skiers.

Thus, Applicant's invention of a Side Force Enhancement device as described herein provides constant additional maneuverability with near instantaneous response based on its placement and size, setting it apart from attempts to enhance maneuverability as currently exist in the prior art.

### BRIEF DESCRIPTION OF THE DRAWINGS

FIG. 1 is plan view of a PO in the form of a slalom ski without the adaptation of Applicant's invention;

FIG. 2 is a side view of the PO represented in FIG. 1.;

FIG. 3 is a plan view of a PO in the form of a slalom ski having been adapted with two Side Force Enhancers in accordance with Applicant's invention;

FIG. 4 is a partial plan view of that portion of a PO having been adapted with Applicant's Side Force Enhancer illustrating the angle of the invention's reference plane to the side edge of the PO;

FIG. 5 is a partial plan view of that portion of a PO having been adapted with Applicant's Side Force Enhancer showing the longitudinal positioning of the invention along the length of the PO;

FIG. 6 is a partial side view of that portion of a PO having been adapted with Applicant's Side Force Enhancer showing the position of the invention relative to the upper and lower surfaces of the PO;

FIG. 7 is an elevational view of the PO in FIG. 6 at cross section A-A; and

FIG. 8 is an elevational view of a cross-section of a PO similar to FIG. 6 however illustrating a mounting angle from the side edge of the PO for the Side Force Enhancer.

### DETAILED DESCRIPTION OF THE INVENTION

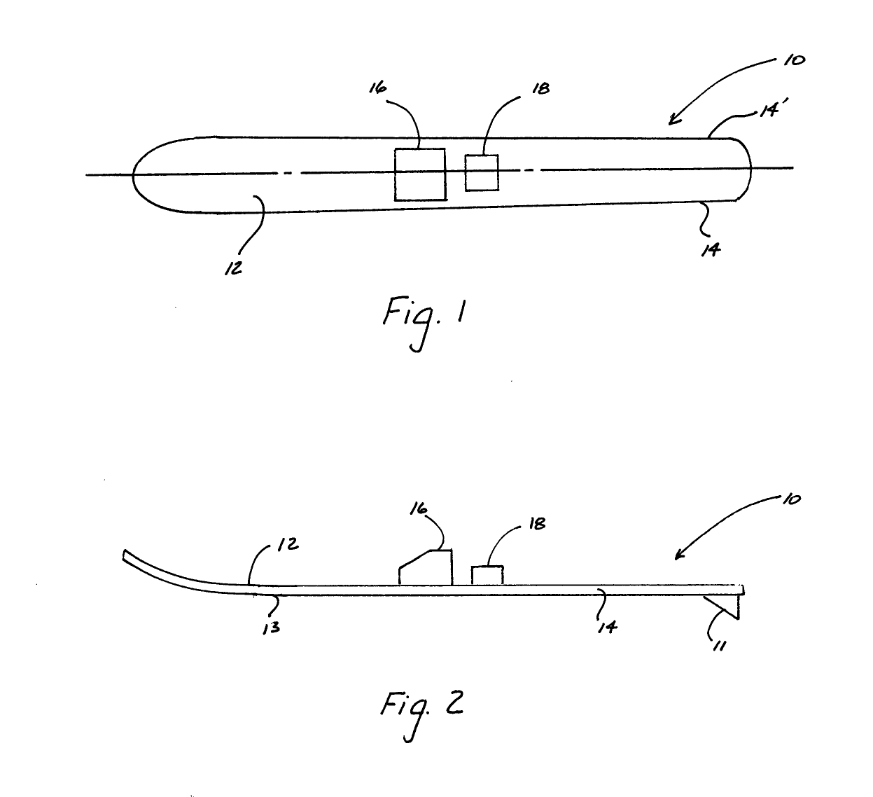

FIG. 1 shows a planing object, here a basic slalom type ski 10, having an upper surface 12 which when in use is in communication with the gas of our gas-liquid environment. Also shown are side edges 14 and 14′, and a boot 16 for insertion of a skier's lead foot and a toe piece or half boot 18 wherein a skier inserts the front of his trailing foot. It can be seen from this FIG. 1 that in most typical cases, the overall planing object is of substantially symmetric configuration. Boot 16 and half boot 18 are located on upper surface 12 a predetermined distance along the length of ski 10.

FIG. 2 shows a side or elevational view of the planing object (“PO”) 10 of FIG. 1, said PO having a stabilizing fin 11 mounted at the tail end of its lower surface 13, said surface normally in communication with the liquid of the aforementioned gas-liquid environment. The relative thickness of the slender PO is further illustrated as is the representative boot 16 and half boot 18 atop upper surface 12 of PO 10.

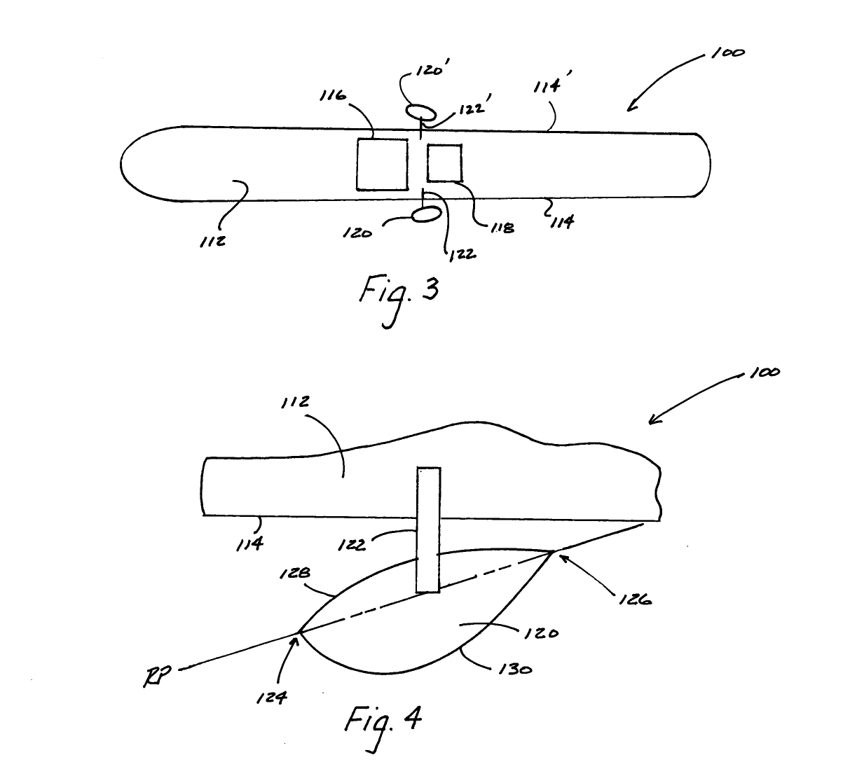

FIG. 3 discloses a PO 100 adapted with Applicant's invention. PO 100 has an upper surface 112, side edges 114 and 114′, boot 116 and half boot 118, and in contrast with PO 10 of FIGS. 1 and 2, side force enhancers (“SFE's”) 120 and 120′. SFE's 120 and 120′ are mounted to PO 100 by mounting means 122 and 122′. These mounting means can be a simple strut 122 as shown in FIG. 4 or may be similarly configured but integrated into the construction of PO 100 be it by moulding, fashioning or other construction means.

FIG. 4, a partial plan view of the embodiment described in FIG. 3 discloses additional detail regarding SFE 120, its features and relationships with PO 100. In this Figure, SFE 120 shows the strut-like mounting means 122. Leading edge 124 and trailing edge 126 define a reference plane RP having a predetermined angle relative to side edge 114. Said reference plane RP is generally within the range of −15° to +15°.

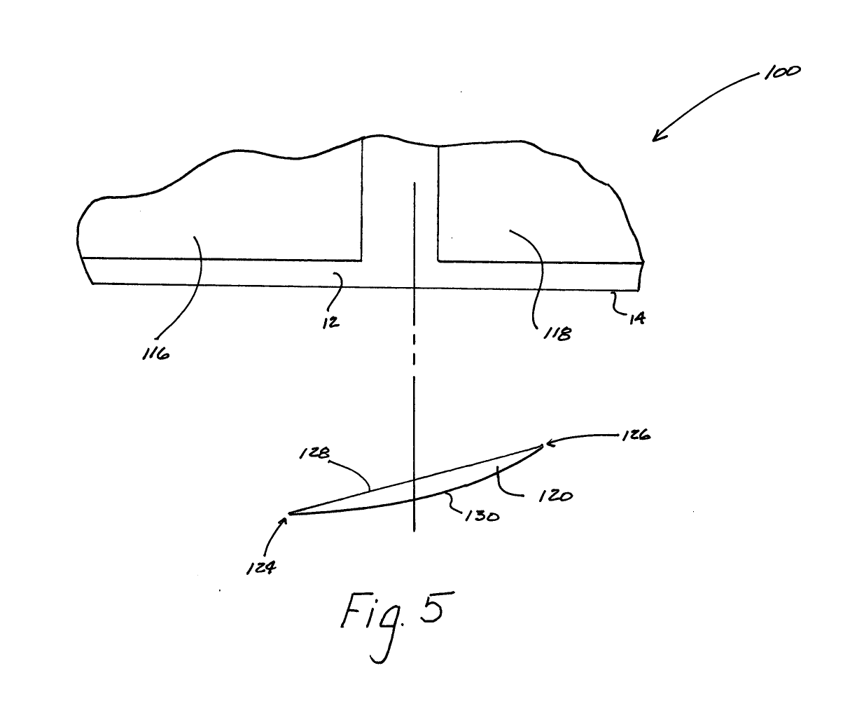

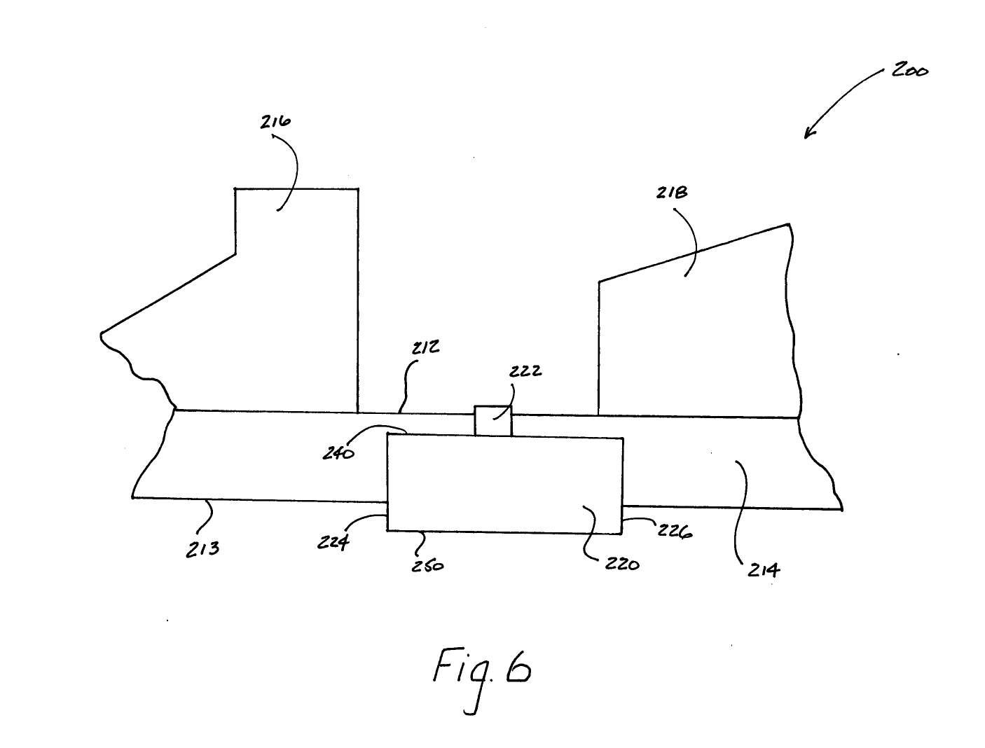

SFE 120 comprises an inner surface 128 and an outer surface 130. Strut 122 is firmly affixed to both PO 100's upper surface 112 and SFE 120's uppermost surface (shown more distinctly in FIG. 6), unless integrated into the construction of PO 100 as described above. FIG. 5 is another representation of a partial plan view of PO 100, in this case having an SFE 120 with planar inner surface 128. Strut 122 is not shown in this illustration. Instead, a transverse axis is represented to illustrate the preferred position of SFE 120 relative to boot 116 and half boot 118 and thereby along the length of side edge 14 of PO 100.

FIG. 6 shows a partial side or elevational view of a portion of PO 200. FIG. 6 highlights the basic constituent of PO 200 including upper surface 212, lower surface 213, side edge 214, boot 216, half boot 218 and SFE 220. Mounting strut 222 affixes SFE 220 to PO 100. Leading edge 224 and 226 are shown as are upper most surface 240 of SFE 220 and lower most surface 250 of SFE 220.

In sizing SFE 220, the ratio of width to height is important. The length of SFE 220 is defined in this Figure as the distance from leading edge 224 to trailing edge 226. The height of SFE 220 is defined in this Figure as the distance between upper most surface 240 and lower most surface 250. In the preferred embodiment of Applicant's invention, this ratio of length to height ranges up to 10:1. Best results have been produced when the length ranges from 10 to 40 millimeters and height ranging from 10 to 30 millimeters.

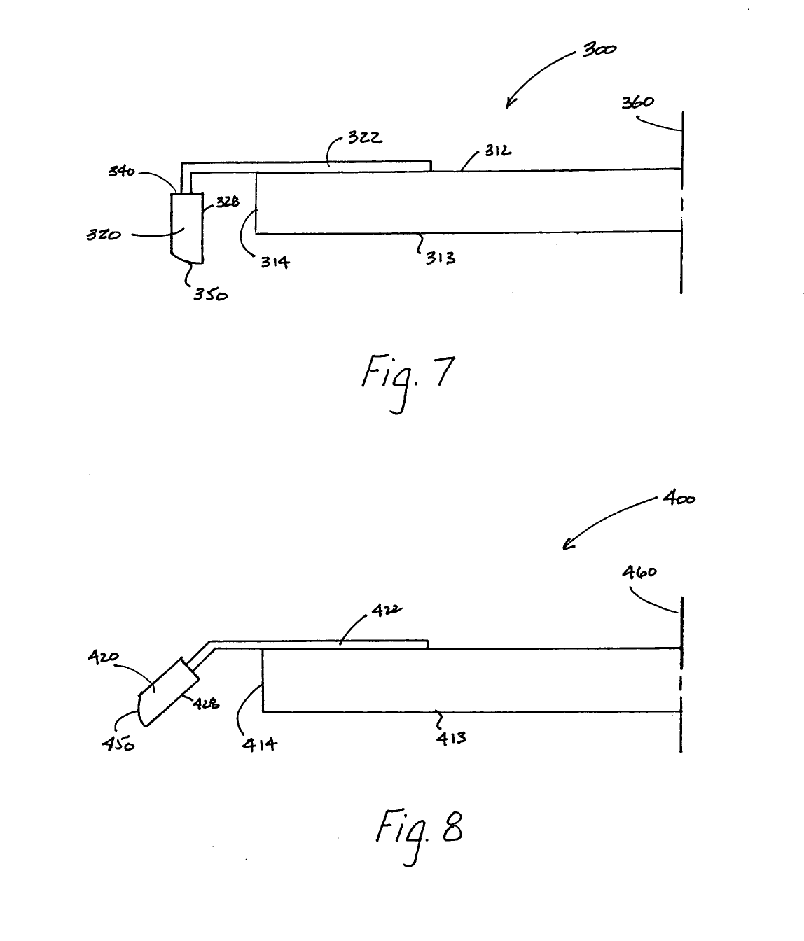

FIG. 7 illustrates more of the relationship of positioning of PO 300 relative to SFE 320. PO 300 similar with other figures discloses an upper surface 312 and lower surface 313, said upper surface 312 being primarily in communication with the gas of the liquid-gas environment and said lower surface 313 being primarily in communication with the liquid of the liquid-gas environment when in use.

Important to note in this Figure are the predetermined distance from PO 300's upper surface 312 and SFE 320's upper most surface 340 (hereafter distance “a”) . Furthermore, a predetermined distance between PO 300's lower surface 313 and SFE 320's lower most surface 350 (hereafter distance “b”) is shown. Side edge 314 is shown proximate to inner surface 328 of SFE 320, defining a predetermined distance “c”.

Tested embodiments included “a” in the range including 0 millimeters up to and including 30 millimeters, “b” in the range from 0 millimeters up to and including 300 millimeters, and “c” in the range including 0 millimeters up to and including 300 millimeters. These distances “a”, “b”, and “c”, determine the preferred spacing of SFE 320 relative to PO 300's dimensions defined by upper surface 312, lower surface 313 and side edge 314.

In a preferred embodiment, distance “a” is substantially equal to 0 millimeters, which distances “b” and “c” were substantially equal to 15 millimeters and 3 millimeters, respectively. The best mode of the invention results from choosing distances “a”, “b”, and “c” in such a way that straight path and level motion of the SFE's lower most surface 350 barely touches the liquid-gas interface.

Also illustrated in FIG. 7 is PO yaw axis 360. As shown in this figure, SFE 320 is substantially parallel to PO 300's Yaw axis.

FIG. 8 is similar to FIG. 7 in that it demonstrates similar dimensional relationships between SFE 420 and PO 400, only in FIG. 8, inner surface 428 of SFE 420 defines an angular relationship between itself and yaw axis 460. The angle between inner surface 428 and the yaw axis, β, depends on the skier's preference and may be designed adjustably as part of the mechanical design of the SFE. Tilting SFE 420 of FIG. 8 away from side edge 414 results in good control of the PO's path when the latter is straight (e.g., a slalom water skier between two buoys), whereas tilting SFE 420 toward side edge 414 supports the initiation of curvature of said PO's path. Applicant's experience utilizing angle 428 (the β angle) ranging between −90° from said side edge 414 to +50° toward said side edge 414 demonstrated a range of approximately −5° to +5° for the preferred embodiment.

In the preferred embodiment, and as illustrated in FIGS. 7 and 8, lower most surfaces 350 and 450 of SFE's 320 and 420 in said figures comprise rounded surfaces.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A planar object with longitudinal axis much greater in length than said object's width and thickness, comprising:
an upper surface, a lower surface, a first side edge, a second side edge, a yaw-axis normal to said upper and lower surfaces and said side edges, said side edges converging to form a tip at one end of said object, said edges converging to form a tail at said object's opposing end;
at least one plate of predetermined thickness proximate to one side edge of said object, said plate having a leading edge and a trailing edge forming a reference plane, said plate forming an inner surface and an outer surface, said plate forming an upper most surface and a lower most surface; and
an attachment means rigidly mounted on said object's upper surface, said attachment means rigidly affixed to said plate's upper most surface.

2. The invention of claim 1 further comprising:
a pair of plates each proximate to one side edge of said object and similarly rigidly attached to said object's upper surface at a substantially similar position along said object's length.

3. The invention of claim 2 wherein:
said plate thickness being substantially uniform.

4. The invention of claim 2 wherein:
said plate's thickness being substantially non-uniform.

5. The invention of claim 2 wherein:
said plate's inner surface being substantially planar.

6. The invention of claim 2 wherein:
said plate's outer surface being substantially curved.

7. The invention of claim 2 wherein:
said plates' length to width ratio being no higher than 10:1.

8. The invention of claim 2 wherein:
said reference plane of said plates forming an angle with said object's corresponding side edge in the range of approximately −10° and +10°.

9. The invention of claim 2 wherein:
said plate's inner surface having a minimum distance from said object's corresponding side edge in the range from 0 to 200 percent of said plate's height.

10. The invention of claim 2 wherein:
said plate's reference plane forming an angle of from approximately −50° to approximately +50° relative with said object's corresponding side edge.

11. The invention of claim 2 wherein:
said plates being positioned proximate to said corresponding side edges at a distance approximating the ratio of the distance between said object's upper surface and said plate's uppermost surface to the distance between said plate's uppermost and lowermost surfaces, or height, said ratio being in the range up to approximately 3.

12. The invention of claim 2 wherein:
said plate's outer surface being rounded as it converges with said inner surface.

13. The invention of claim 2 further comprising:
said plate being positioned relative to said object such that when said object is in hydrodynamic planar motion in a liquid-gas environment, said positioning providing a gap between said plate and said object's side edge at least partially in communication with said gas layer.

14. The invention of claim 2 further comprising:
said plate being positioned relative to said object such that when said object is in hydrodynamic planar motion in a liquid-gas environment, said positioning providing no gap between said plate and said object's side edge in communication with said gas layer.

15. The invention of claim 2 wherein:
said plate's reference plane forming an angle of from approximately −30° to approximately +30° relative to said object's yaw axis.
